(19) United States
(12) Patent Application Publication
(10) Pub. No.: US 2015/0257237 A1
(43) Pub. Date: Sep. 10, 2015

(54) SYSTEMS AND METHODS FOR MAGNETIC LAMP SENSING

(71) Applicant: Xenon Corporation, Wilmington, MA (US)

(72) Inventor: Roger WILLIAMS, Acton, MA (US)

(21) Appl. No.: 14/638,499

(22) Filed: Mar. 4, 2015

Related U.S. Application Data
(60) Provisional application No. 61/947,864, filed on Mar. 4, 2014.

(51) Int. Cl. H05B 37/02

(52) U.S. Cl. CPC H05B 37/0227

(57) ABSTRACT

An apparatus for determining that a discharge lamp is properly inserted in a socket. The apparatus includes a gas discharge lamp, comprising a first end and a second end, a magnet positioned at the first end of the gas discharge lamp, a sensor configured to detect the presence of the magnet, and a control system configured to receive a signal from the sensor, and thereby delay or stop operation of the gas discharge lamp when the received sensor signal indicates the magnet is not detected.

### CROSS REFERENCE TO RELATED APPLICATIONS

This application claims the benefit of priority under 35 U.S.C. 119(e) to U.S. Provisional Application No. 61/947,864, entitled “Systems and Methods for Magnetic Lamp Sensor”, filed Mar. 4, 2014, the content of which are hereby incorporated in its entirety.

### TECHNICAL FIELD

This disclosure relates to lamp sensors, specifically to detecting a lamp using a magnetic sensor.

### BACKGROUND

This disclosure relates to systems and methods for detecting the presence of a lamp, including gas discharge lamps such as xenon flash lamps.

Gas discharge lamps contain a rare gas, such as xenon or krypton, in a transparent bulb. The gas may be at pressures above or below atmospheric pressure. The lamps have a cathode and an anode through which an electrical current is provided to create an electrical arc. For the gas to conduct the electrical energy between the electrodes, the gas is ionized to reduce its electrical resistance. Once the gas is ionized, electrical energy conducts through the gas and excites the gas molecules. When the molecules return to their unexcited energy state, they release light energy.

### SUMMARY

In some embodiments, systems and methods are disclosed for detecting a gas discharge lamp. In some embodiments, the system comprises a gas discharge lamp having a cathode end and an anode end; and one end of the lamp includes a magnet. The system includes a sensor configured to detect the magnet, which indicates the presence and proper positioning of the lamp. Methods of making and using these systems are disclosed. The methods include providing a magnet on one end of a gas discharge lamp; and detecting the magnet using a sensor that is in proximity to the magnet. The sensor can send an electrical signal to a lamp control system to indicate the presence of the magnet, and the control system translates the received electrical signal into a switch or error message.

In some embodiments, an apparatus is disclosed for determining that a discharge lamp is properly inserted in a socket. The apparatus comprises a gas discharge lamp, the gas discharge lamp comprising a first end and a second end; a magnet, the magnet positioned at the first end of the gas discharge lamp; a sensor, the sensor configured to detect the presence of the magnet; and a control system, the control system configured to receive a signal from the sensor, and thereby delay or stop operation of the gas discharge lamp when the received sensor signal indicates the magnet is not detected.

In some embodiments, the first end of the gas discharge lamp includes a first polarity and the second end of the gas discharge lamp includes a second polarity, wherein the first polarity differs from the second polarity. In some embodiments, the apparatus further comprises a pulse forming network. In some embodiments, the pulse forming network is configured to receive a signal from the control system, the pulse forming network including a first socket and a second socket, the first socket configured to receive the first end of the gas discharge lamp and the second socket configured to receive the second end of the gas discharge lamp, the pulse forming network configured to apply an electrical potential across the first end and the second end of the gas discharge lamp based on the received control system signal.

In some embodiments, the received control system signal is an instruction not to apply the electrical potential across the first end and the second end of the gas discharge lamp when the sensor does not detect the magnet. In some embodiments, the control system is configured to convert the received sensor signal into an error message when the sensor does not detect the magnet. In some embodiments, the sensor is a hall sensor.

In some embodiments, the gas discharge lamp further comprises lamp tubing including a first end forming the first end of the gas discharge lamp and a second end forming the second end of the gas discharge lamp, a first mounting cylinder attached to the first end of the lamp tube, and a second mounting cylinder attached to the second end of the lamp tube.

In some embodiments, the magnet is positioned inside the first mounting cylinder. In some embodiments, the sensor is positioned such that the sensor does not contact the gas discharge lamp or circuitry associated with the pulse forming network, the circuitry comprising at least one of high voltage circuitry and high current circuitry.

In some embodiments, a method is disclosed for determining that a discharge lamp is properly inserted in a socket. In some embodiments, the method comprises receiving, by a computing device, first data from a sensor, the first data indicative of when the sensor detects a magnet positioned in a gas discharge lamp, the gas discharge lamp positioned within a sensing range of the sensor, the gas discharge lamp comprising a first end and a second end, the first end and the second end connected to a pulse forming network, and transmitting, by the computing device, second data to the pulse forming network based on the first data, the second data indicating a time interval after which the pulse forming network applies an electrical potential to the gas discharge lamp.

In some embodiments, the second data provides an instruction not to apply the electrical potential across the first end and the second end of the gas discharge lamp when the sensor does not detect the magnet. In some embodiments, the second data provides an error message when the sensor does not detect the magnet. In some embodiments, the sensor is positioned such that the sensor does not contact the gas discharge lamp or circuitry for powering the gas discharge lamp, the circuitry comprising at least one of high voltage circuitry and high current circuitry.

In some embodiments, a gas discharge lamp system is disclosed for use in a lamp sensing system. In some embodiments, the discharge lamp system comprises lamp tubing, the lamp tubing comprising a first end and a second end; a first mounting cylinder, the first mounting cylinder configured to attach to the first end of the lamp tubing; and a magnet, the magnet positioned inside the first mounting cylinder, the first mounting cylinder attached to the first end of the lamp tubing such that a connection of the first mounting cylinder with a first socket associated with a pulse forming network results in a transmission of a signal from a sensor arranged within a sensing range of the first socket to a control system indicating when the sensor detects the magnet.

In some embodiments, the lamp tubing comprises a linear shape, a “U” shape, a helical shape, or a spiral design. In some embodiments, the signal provides an instruction not to apply the electrical potential across the first end and the second end of the gas discharge lamp when the sensor does not detect the magnet. In some embodiments, the signal provides an error message when the sensor does not detect the magnet. In some embodiments, the sensor is positioned such that the sensor does not contact the gas discharge lamp or circuitry associated with the pulse forming network, the circuitry comprising at least one of high voltage circuitry and high current circuitry. In some embodiments, the gas discharge lamp system further comprises a second mounting cylinder, the second mounting cylinder configured to attach to the second end of the lamp tubing, such that the gas discharge lamp system comprises a symmetrical shape around an axis intersecting a mid-point of the lamp tubing between the first mounting cylinder and the second mounting cylinder.

### BRIEF DESCRIPTION OF THE DRAWINGS

Features and advantages of various embodiments are illustrated in the accompanying drawings.

FIG. 1 is an illustration of a system according to some embodiments of the present disclosure.

FIG. 2 shows how certain components of a lamp system are assembled, according to some embodiments of the present disclosure.

FIG. 3 shows how a magnet can be place inside a lamp mounting cylinder, according to some embodiments of the present disclosure.

FIG. 4 shows a lamp socket and lamp, according to some embodiments of the present disclosure.

### DETAILED DESCRIPTION

In establishing a proper connection between a lamp and a lamp socket, it is a problem for the lamp to be “flipped,” such that the cathode is in the anode position, and vice versa. This results in the lamp system malfunctioning or not functioning at all, which decreases the efficiency and reliability of lamp systems. Another issue is in determining the presence of a discharge lamp in an enclosed non-transparent lamp housing. In some cases, limit switches can detect the presence of a lamp through contact with the lamp envelope. However, there are disadvantages associated with using limit switches. For example, the moving mechanical parts of limit switches can wear out.

Lamp systems, including gas discharge lamps, do not function properly if the lamp is not properly connected or if a lamp is not present. In some aspects, the lamp sensing systems and methods described herein detect the presence of a lamp to improve the efficiency and reliability of lamp systems. The systems and methods allow the presence of a lamp to be detected when no current is flowing through the lamp. In some embodiments, a low voltage circuit can be used to detect the presence of a high voltage lamp. The disclosure reduces the hazards associated with the operation of a high voltage flash lamp circuit with no flash lamp present. The disclosure also reduces the hazards associated with the operation of a high voltage flash lamp circuit with a lamp that is installed improperly. Running a lamp system with high voltage without a lamp or with a lamp that is installed improperly can damage the lamp, the lamp casing, the electrical circuitry or surrounding objects.

In some embodiments, the disclosed systems include a gas discharge lamp. Examples of gas discharge lamps that can be used in the instant disclosure include but are not limited to xenon flash lamps, mercury lamps, metal halide lamps, and sodium lamps. A gas discharge lamp contains a gas and has a cathode, an anode, and an ignition electrode. The electrical charge between the cathode and anode is of sufficient voltage and current to create an electrical arc between the cathode and the anode. A gas discharge lamp can be symmetrical. While there are sometimes markings to indicate which end of the lamp corresponds to the cathode and which end of the lamp corresponds to the anode, gas discharge lamps are often still placed into lamp sockets backwards.

The presence and orientation of gas discharge lamps can be hard to detect for at least two reasons. The first reason is that gas discharge lamps do not have a filament. Without a filament, current sensing circuitry could not be used to detect the presence of a lamp when the lamp is not in operation. While a limit switch can be used to detect the presence of a lamp, the mechanical mechanism can be unreliable and any contact with the hot glass envelope of an operational lamp can create thermal stresses in the envelope that can lead to lamp malfunction or failure. Gas discharge lamps are also difficult to detect because it is not feasible to apply voltage to the lamp to determine whether the lamp is present. Photo cells can be used to detect the light being emitted from a lamp for lamps running on lower voltages. However, it would not be desirable to run a high voltage through a gas discharge lamp system with a missing or improperly installed lamp. It would be advantageous to have a lamp sensing system for gas discharge lamps that does not require running current through the lamp system.

Gas discharge lamps may be used in a variety of applications, including spectroscopic analysis, photography, biological sterilization, and sintering particles (for example, in the field of printed electronics). Because the emissions spectra of some gas discharge lamps, for example a xenon flash lamp, includes ultraviolet (UV) wavelengths, these lamps may be used for decontamination. Likewise, the UV light emitted by such lamps may be used for sanitization, decontamination, and sterilization, and flash curing. A sintering system using pulsed light and/or high intensity continuous light can bind nanometals to one another and onto substrates using lower temperatures than those used with conventional sintering systems. One way to perform such sintering is with a flash lamp system that employs a high intensity flash of light to melt or sinter metallic nanoparticles to significantly increase the conductivity of the material. Gas discharge lamps can be useful for simulating sunlight and can be used in the solar panel testing industry.

Some types of gas discharge lamps may be operated in a pulsed fashion such that a train of light pulses is emitted from the lamp rather than a continuous light emission. In this type of lamp, the electrical current provided across the cathode and anode is released in short bursts, rather than supplied in a continuous manner. This results in a single discharge or “flash” of light.

Embodiments of systems and methods for a magnetic lamp sensor are described below.

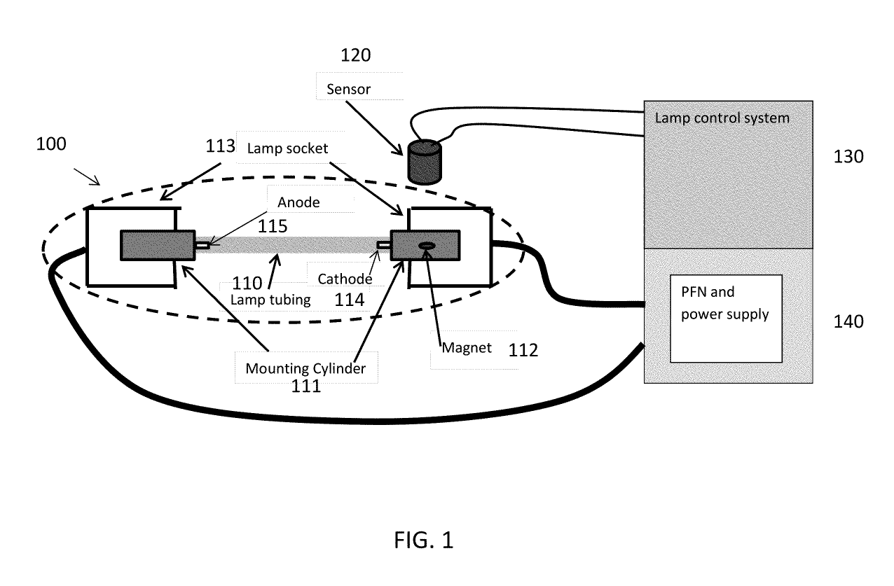

FIG. 1 is a graphic representation of a lamp sensing system, according to some embodiments of the present disclosure. FIG. 1 shows a lamp system 100, a magnetic sensor 120, a lamp control system (also referred to herein as “control system”) 130, and a pulse forming network (PFN) and power supply 140. The lamp system 100 includes a cathode 114 and an anode 115 that extend through opposite ends of a lamp tube 110. In some embodiments, the lamp also includes an ignition electrode that is formed by a wire encircling a portion of the lamp tube 110. In other embodiments, the ignition electrode is located inside the lamp tube 110. In other embodiments, the cathode 114 or anode 115 acts as the ignition electrode. A lamp can be elongated in shape and include lamp tubing with a first end corresponding to a cathode and a second end corresponding to an anode. A lamp can also be other shapes, e.g., U-shaped, spiral-shaped, and bow-shaped. In some embodiments, a gas discharge lamp system including tubing and mounting cylinders is symmetrical about an axis intersecting the lamp tubing between a first mounting cylinder and a second mounting cylinder. The lamp system 100 includes a magnet 112 that is located inside a mounting cylinder 111. A mounting cylinder 111 is attached to both ends of the lamp tubing 110. In some embodiments, the magnet 112 is positioned on or in one of the two mounting cylinders 111. For example, the magnet 112 can be fitted into one of the two mounting cylinders 111 before the mounting cylinder 111 is attached to one end of the lamp tubing 110. In some embodiments, the magnet is positioned relative to the lamp such that the magnet does not interfere with attaching the lamp to a socket. The magnet 112 can be detected with a sensor 120, which is configured to detect the magnet 112 and is operably connected to the lamp control system 130. The lamp control system 130 is operably connected to the PFN and power supply 140. Detection of the magnet 112 using the sensor 120 confirms the presence of the lamp and that it is properly oriented for the lamp system to function. These systems and methods are used to monitor whether or not the lamp is present and can function properly.

When the lamp system functions properly, in some embodiments, an electrical potential is applied by the PFN and power supply 140 to generate an electrical potential between cathode 114 and anode 115. This electrical potential is high enough to create an electrical arc through the gas in lamp tube 110 after the gas is ionized. After ionization, the conductivity of the gas increases, allowing an arc to form between cathode 114 and anode 115.

In the disclosed methods and systems, the lamp tubing can be made of borosilicate, Pyrex, sapphire or other transparent material with a high melting point. In some embodiments, the lamp tubing 110 is a quartz lamp tubing.

In some embodiments, the mounting cylinder 111 attaches to the lamp socket 113. The end of the mounting cylinder 111 that houses the magnet 112 is inserted into the lamp socket 113. The lamp socket 113, which can include a socket for receiving a first end of the lamp and a second end for receiving a second end of the lamp, can be operably connected to a PFN and power supply 140. A PFN is an electric circuit that accumulates electrical energy over a comparatively long time, and then releases the stored energy for a comparatively brief duration for various pulsed power applications. The power supply 140 provides power to the PFN, and the PFN provides a pulsed power to the lamp.

### Sensors

In some embodiments, when a lamp is properly positioned, the magnet 112 is within a sensing range of the sensor 120. The sensor is positioned such that there is no physical contact between sensor 120 and the lamp or high voltage/high current circuitry that powers the lamp. In some embodiments, the sensor 120 is a Hall effect sensor. A Hall effect sensor 120 is a transducer that varies an output voltage in response to a magnetic field. The Hall effect sensor 120 can be placed relative to the lamp socket 113 such that the magnet 112 in combination with the sensor 120 produces a control signal (also referred to herein as “data”). In some embodiments, the sensor is an Omni-polar device. An Omni-polar device can switch when in proximity to either a north or south pole of the magnet. In some embodiments, when the Hall effect sensor 120 detects a magnetic field corresponding to the magnet 120, it can send an electrical signal to the lamp control system 130. To avoid electrical noise and arcing issues, the high voltage PFN/power supply circuitry is kept physically and electrically isolated from the low voltage control circuitry. The lamp control system 130 can comprise a computing device including microprocessors to interpret the electrical signal. Various other sensors can also be used—some examples are described in Honeywell, “MICRO SWITCH Sensing and Control,” Honeywell, “SS41F/SS41G Series Product Sheet,” and Williams, “Examples of Sensor Interaction Circuits.”

When the lamp system functions properly, the sensor 120 sends an electrical signal to the lamp control system 113 indicating that the sensor detects the magnet in the lamp. However, if a lamp is not present in the socket, the sensor can send a signal to the lamp control system to indicate that it does not sense the magnet. Similarly, if an incompatible lamp is inserted or if a compatible lamp is inserted backwards, such that the cathode is in the anode position, and vice versa, the sensor 120 can also send a signal indicating it does not detect the magnet 112. This can be used as a feedback system to monitor whether or not the lamp is present and properly positioned.

In some embodiments, the lamp control system 113 can include a computing device to convert the signal received from the sensor 120 to output an error message. In some embodiments, the lamp control system 113 can act as a switch and delay or stop the PFN from activating. The lamp control system 113 can delay or stop the PFN from activating by preventing the power supply from charging the PFN's capacitor, by turning off the high voltage supply an discharging the PFN's capacitor, or by preventing the trigger pulse from begin generated to ignite the lamp. The methods and steps illustrated in FIG. 1 allow the detection of a lamp and ensure proper functioning of the lamp system.

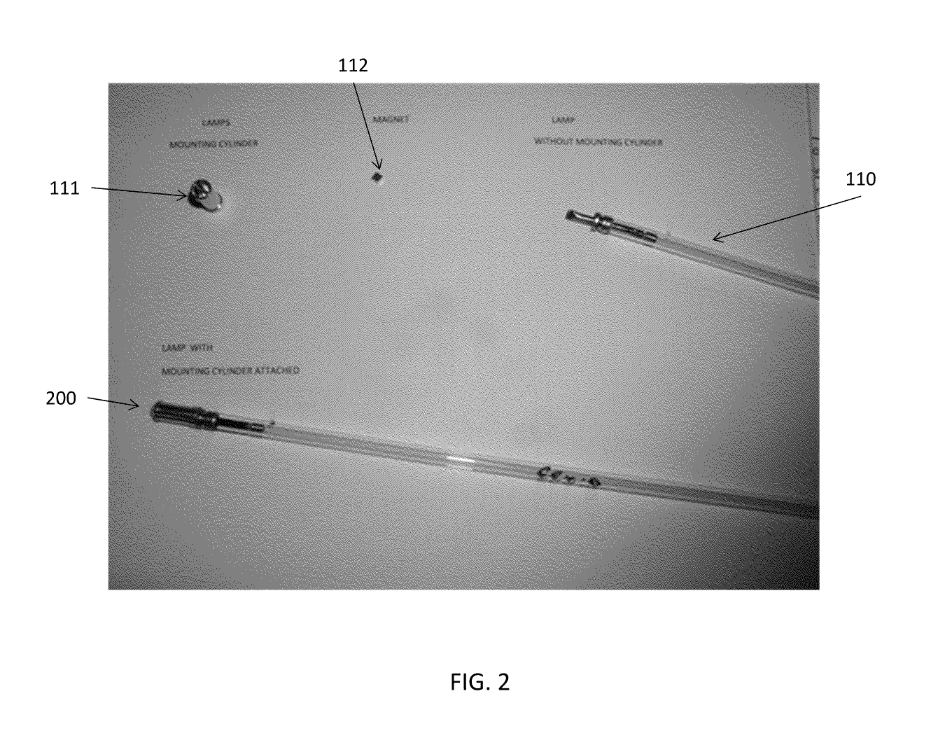

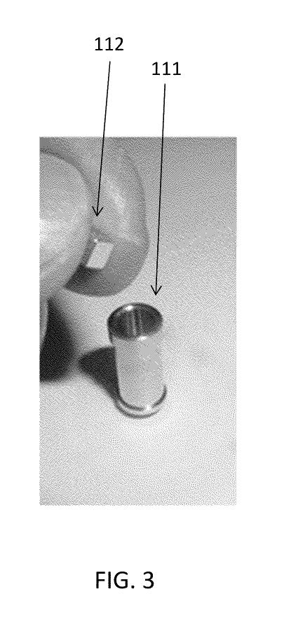

FIG. 2 shows certain components of a lamp system according to some embodiments of the present disclosure. FIG. 2 shows a mounting cylinder 111, a magnet 112, and a lamp tube 110. In some embodiments, the magnet 112 is placed inside the mounting cylinder 111, which is then attached to the lamp, as shown in 200. FIG. 3 shows how a magnet 112 can be placed inside a mounting cylinder 111, according to some embodiments of the present disclosure. In other embodiments, the magnet 112 can be deposited directly into the mounting cylinder 111.

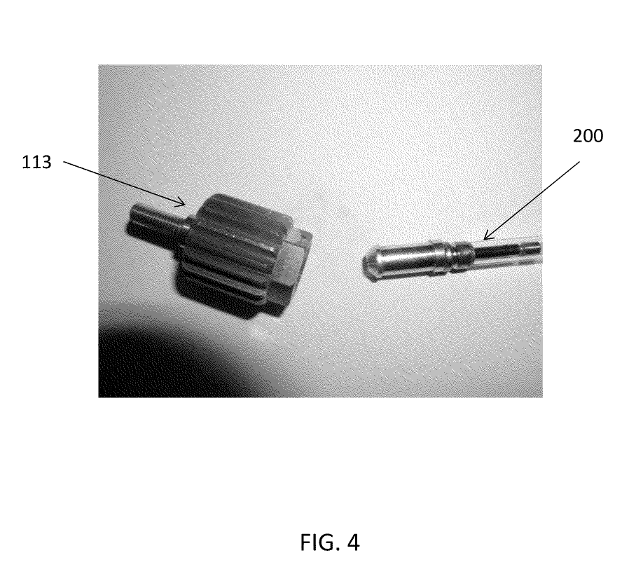

FIG. 4 shows the cathode end of the lamp and a portion of the lamp tube 200, according to some embodiments of the present disclosure. In some embodiments, the cathode end of the lamp containing the mounting cylinder and the magnet can be inserted into a lamp socket 113.

Embodiments of the disclosure work with lamps operating across a variety of operating parameters, such as those listed below.

Range of Operating Parameters:
Lamp operation: flash or continuous.
Lamp type: metal halide, mercury, sodium, fluorescent, flash.
Lamp wattage: 1 to 10,000 watts.
Pulse Duration: 0.1-100,000 microseconds measured at ⅓ peak energy or a continuous lamp.
Energy per Pulse: 1-5,000 joules.
Lamp Configuration (shape): Linear, “U,” helical or spiral design.
Spectral Output: 100-1,000 nanometers.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. An apparatus for determining that a discharge lamp is properly inserted in a socket, the apparatus comprising:
a gas discharge lamp, the gas discharge lamp comprising a first end and a second end;
a magnet, the magnet positioned at the first end of the gas discharge lamp;
a sensor, the sensor configured to detect the presence of the magnet; and
a control system, the control system configured to receive a signal from the sensor, and thereby delay or stop operation of the gas discharge lamp when the received sensor signal indicates the magnet is not detected.

2. The apparatus of claim 1, wherein the first end of the gas discharge lamp includes a first polarity and the second end of the gas discharge lamp includes a second polarity, wherein the first polarity differs from the second polarity.

3. The apparatus of claim 2 further comprising a pulse forming network,
the pulse forming network configured to receive a signal from the control system,
the pulse forming network including a first socket and a second socket,
the first socket configured to receive the first end of the gas discharge lamp and
the second socket configured to receive the second end of the gas discharge lamp,
the pulse forming network configured to apply an electrical potential across the first end and the second end of the gas discharge lamp based on the received control system signal.

4. The apparatus of claim 3, wherein the received control system signal is an instruction not to apply the electrical potential across the first end and the second end of the gas discharge lamp when the sensor does not detect the magnet.

5. The apparatus of claim 1, wherein the control system is configured to convert the received sensor signal into an error message when the sensor does not detect the magnet.

6. The apparatus of claim 1, wherein the sensor is a hall sensor.

7. The apparatus of claim 1, wherein the gas discharge lamp further comprises:
lamp tubing including a first end forming the first end of the gas discharge lamp and
a second end forming the second end of the gas discharge lamp,
a first mounting cylinder attached to the first end of the lamp tube, and
a second mounting cylinder attached to the second end of the lamp tube.

8. The apparatus of claim 7, further wherein the magnet is positioned inside the first mounting cylinder.

9. The apparatus of claim 3, wherein the sensor is positioned such that the sensor does not contact the gas discharge lamp or circuitry associated with the pulse forming network, the circuitry comprising at least one of high voltage circuitry and high current circuitry.

10. A method for determining that a discharge lamp is properly inserted in a socket, the method comprising:
receiving, by a computing device, first data from a sensor, the first data indicative of when the sensor detects a magnet positioned in a gas discharge lamp, the gas discharge lamp positioned within a sensing range of the sensor, the gas discharge lamp comprising a first end and a second end, the first end and the second end connected to a pulse forming network, and
transmitting, by the computing device, second data to the pulse forming network based on the first data, the second data indicating a time interval after which the pulse forming network applies an electrical potential to the gas discharge lamp.

11. The method of claim 10, wherein the second data provides an instruction not to apply the electrical potential across the first end and the second end of the gas discharge lamp when the sensor does not detect the magnet.

12. The method of claim 10, wherein the second data provides an error message when the sensor does not detect the magnet.

13. The method of claim 10, wherein the sensor is positioned such that the sensor does not contact the gas discharge lamp or circuitry for powering the gas discharge lamp, the circuitry comprising at least one of high voltage circuitry and high current circuitry.

14. A gas discharge lamp system for use in a lamp sensing system, the discharge lamp system comprising:
lamp tubing, the lamp tubing comprising a first end and a second end;
a first mounting cylinder, the first mounting cylinder configured to attach to the first end of the lamp tubing; and
a magnet, the magnet positioned inside the first mounting cylinder, the first mounting cylinder attached to the first end of the lamp tubing such that a connection of the first mounting cylinder with a first socket associated with a pulse forming network results in a transmission of a signal from a sensor arranged within a sensing range of the first socket to a control system indicating when the sensor detects the magnet.

15. The gas discharge lamp system of claim 14, wherein the lamp tubing comprises a linear shape, a “U” shape, a helical shape, or a spiral design.

16. The gas discharge lamp system of claim 14, wherein the signal provides an instruction not to apply the electrical potential across the first end and the second end of the gas discharge lamp when the sensor does not detect the magnet.

17. The gas discharge lamp system of claim 14, wherein the signal provides an error message when the sensor does not detect the magnet.

18. The gas discharge lamp system of claim 14, wherein the sensor is positioned such that the sensor does not contact the gas discharge lamp or circuitry associated with the pulse forming network, the circuitry comprising at least one of high voltage circuitry and high current circuitry.

19. The gas discharge lamp system of claim 14, further comprising a second mounting cylinder, the second mounting cylinder configured to attach to the second end of the lamp tubing, such that the gas discharge lamp system comprises a symmetrical shape around an axis intersecting a mid-point of the lamp tubing between the first mounting cylinder and the second mounting cylinder.
